(19) United States
(12) Patent Application Publication
(10) Pub. No.: US 2024/0201491 A1
(43) Pub. Date: Jun. 20, 2024

(54) COMPACT WIDE FIELD OF VIEW WINDSHIELD HEAD UP DISPLAY WITH HYBRID REFLECTING INTERMEDIATE IMAGE SCREEN

(71) Applicant: Atieva, Inc., Newark, CA (US)

(72) Inventors: Wiebke Eckstein, Woodside, CA (US); Hans-Christoph Eckstein, Woodside, CA (US)

(21) Appl. No.: 18/518,047

(22) Filed: Nov. 22, 2023

Related U.S. Application Data
(60) Provisional application No. 63/384,668, filed on Nov. 22, 2022.

(51) Int. Cl. G02B 27/01; G02B 5/02

(52) U.S. Cl. CPC G02B 27/0101; G02B 5/0284; G02B 2027/011

(57) ABSTRACT

A windshield head up display system for an occupant of a vehicle comprises: a picture generating unit comprising a light source, the picture generating unit generating light for the head up display system in a first light path; a hybrid reflective intermediate image screen characterized by at least i) a field correction term that defines a carrier shape of the hybrid reflective intermediate image screen and ii) a diffuser term that defines a surface structure on the hybrid reflective intermediate image screen, wherein the hybrid reflective intermediate image screen receives the light from the picture generating unit; and at least one mirror that receives the light, after reflection and diffusion at the hybrid reflective intermediate image screen, in a second light path; wherein the head up display system is configured so that a windshield of the vehicle receives the light after reflection at the mirror, and reflects the light toward the occupant.

### CROSS-REFERENCE TO RELATED APPLICATION

This application claims priority to U.S. Patent Application No. 63/384,668, filed on Nov. 22, 2022, and entitled “COMPACT WIDE FIELD OF VIEW HEAD UP DISPLAY WITH CURVED REFLECTING SCATTERING INTERMEDIATE IMAGE PLANE,” the disclosure of which is incorporated by reference herein in its entirety.

### TECHNICAL FIELD

This document relates to a compact wide field of view windshield head up display with a hybrid reflecting intermediate image screen.

### BACKGROUND

Some attempts have been made in the automotive industry to design a windshield head up display (HUD) in vehicles, typically to provide the driver with information related to the driving. While these previous systems all involve projecting imagery onto the vehicle's windshield, they typically do not have any form of intermediate image plane in the windshield HUD system. A windshield HUD may contain a picture generating unit (PGU), some tailored fold mirrors which project the image from the PGU in the virtual image plane, and elements that handle stray light. In most windshield HUDs the PGU, e.g., a thin-film transistor (TFT) display, is projected in the virtual image plane. As such, these systems do not support wide angle projection with high brightness that also provides a sufficiently great virtual image distance (VID). For example, they are often limited to a VID of about 2.5 meters or at least less than 8 m. In some windshield HUDs the PGU is projecting the image on an additional transmissive intermediate image screen which allows a higher degree of freedom in the optical design. They usually require an additional field lens to correct the field angles of the illumination to achieve a good brightness and homogeneity in the eye box and also require package space to allow the necessary optical distance between IIP and projection optics.

Some previous HUD systems have relied on a TFT display with light emitting diode (LED) illumination. However, these systems are typically susceptible to the impact of sunlight on the TFT display, which can lead to damage. While TFT systems may be able to generate relatively greater VIDs, this requires significant magnification and substantially reduces the brightness. As a result, a much more elaborate LED illumination design may be required, and due to the high magnification the sun load, which is in reverse direction of the projection path and can be focused on the display, may be considerably higher.

### SUMMARY

In an aspect, a windshield head up display system for an occupant of a vehicle comprises: a picture generating unit comprising a light source, the picture generating unit generating light for the head up display system in a first light path; a hybrid reflective intermediate image screen characterized by at least i) a field correction term that defines a carrier shape of the hybrid reflective intermediate image screen and ii) a diffuser term that defines a surface structure on the hybrid reflective intermediate image screen, wherein the hybrid reflective intermediate image screen receives the light from the picture generating unit; and at least one mirror that receives the light, after reflection and diffusion at the hybrid reflective intermediate image screen, in a second light path; wherein the head up display system is configured so that a windshield of the vehicle receives the light after reflection at the mirror, and reflects the light toward the occupant.

Implementations can include any or all of the following features. The carrier shape of the hybrid reflective intermediate image screen is curved. The field correction term is described as an optical freeform. The optical freeform is a two-dimensional polynomial function. The field correction term is described as a biconic surface function. The field correction term is described as a cylindrical surface function. The hybrid reflective intermediate image screen has a radius of curvature of about 1000-300 millimeters and is convex. The field correction term is described by an anamorphic lens function. The hybrid reflective intermediate image screen has a convex shape facing an origin of the first light path. The surface structure has a total height of at least two and a half times a longest illumination wavelength used, and wherein lateral structure sizes are greater than five times the longest illumination wavelength. The diffuser term is realized by a deterministic non-stochastical computed surface according to a specified height profile. The surface structure has no steps, jumps or edges in both lateral directions, and wherein a first derivative of a surface height function is continuous. The surface structure is described by a repetition of one or more unit cells. The unit cell is computed by an Iterative Fourier Transform Algorithm. The first light path intersects the second light path. The windshield head up display system further comprises a second mirror that receives the light, after reflection at the first mirror, in a third light path, and wherein at least one of the first or second mirror is curved. The first mirror is flat and the second mirror is curved. The first mirror faces away from the occupant, and wherein the second mirror faces toward the occupant. An origin of the first light path is located below the first and second mirrors in a z-direction of a vehicle coordinate system. An origin of the first light path is located between the first and second mirrors in an x-direction of a vehicle coordinate system. The second mirror is positioned forward of the first mirror relative to an x-direction of a vehicle coordinate system. The windshield head up display system further comprises a glare trap positioned between the second mirror and the windshield. The glare trap is in part formed by a transparent polymer cover. An origin of the first light path is located below the hybrid reflective intermediate image screen in a z-direction of a vehicle coordinate system. The windshield head up display system is configured to generate a virtual image for the occupant, the virtual image positioned about 10-30 meters from the occupant. A field of view of the head up display system is specified as a first angle by a second angle, the first angle being about 10-20 degrees, and the second angle being about 3-10 degrees. The hybrid reflective intermediate image screen is formed by multiple unit cells that satisfy a periodic boundary condition. The hybrid reflective intermediate image screen is formed by multiple unit cells that are all identical to each other. The hybrid reflective intermediate image screen is formed by multiple unit cells that are not all identical to each other. The hybrid reflective intermediate image screen comprises a volume holographic polymer element. The volume holographic polymer element comprises a photopolymer film and a carrier substrate. The carrier substrate comprises at least one selected from the group consisting of polycarbonate and polyethylene. The windshield head up display system further comprises a cover layer positioned against an opposite side of the photopolymer film than where the carrier substrate is positioned. The hybrid reflective intermediate image screen comprises a curved volume holographic polymer element. The hybrid reflective intermediate image screen comprises a plane volume holographic polymer element. The hybrid reflective intermediate image screen is formed by gray scale lithography. The surface structure is formed in a material selected from the group consisting of polymer or plastic. The material is coated with a reflective layer. The reflective layer includes metal. The reflective layer includes a combination of metal and dielectric layers.

### BRIEF DESCRIPTION OF DRAWINGS

FIGS. 1A-1C show schematic examples of windshield head up display (HUD) systems using a hybrid reflective intermediate image plane.

FIG. 2 shows an example of light paths in the windshield HUD system of FIG. 1A.

FIG. 3A shows another example of light paths in the windshield HUD system of FIG. 1A.

FIG. 3B shows an example of a rectangular diffusor spread for the hybrid reflecting IIS of FIG. 3A.

FIG. 4 shows an example of a non-stochastic microoptical computed surface that can be used with diffusers described herein.

FIG. 5 shows an example of a unit cell for a diffuser that can be used with windshield HUD systems described herein.

FIG. 6 shows an example of a height profile of the non-stochastic microoptical computed surface of FIG. 5.

FIGS. 7A-7B show examples of the non-stochastic microoptical computed surface of FIG. 5.

FIGS. 8A-8G show examples of how a reflective structure can be calculated and assembled.

FIG. 9 shows an example of the arrangement of a unit cell in an 4×4 array through repetition.

FIGS. 10-11 show examples of diffusor arrangements that can be formed from unit cells.

FIG. 12 shows an example of a diffusor specification regarding an eye box size and position.

FIG. 13 shows an example of an intensity distribution in the farfield for the non-stochastic microoptical computed surface of FIG. 5.

FIG. 14 shows an example of an irradiance at an eye box.

FIGS. 15A-15C show examples of hybrid reflecting IISs.

FIGS. 16A-16B show an example of a windshield HUD system.

Like reference symbols in the various drawings indicate like elements.

### DETAILED DESCRIPTION

This document describes examples of systems and techniques for a compact windshield HUD system that provides a wide field of view using a hybrid reflective intermediate image screen (IIS) that is characterized by at least a field correction term and a diffuser term. The shape of the hybrid reflecting IIS can be decomposed in a specific curvature of the mirror and a specific computed diffuser height profile (e.g., with structure sizes in the micrometer range for VIS) which delivers a certain scattering distribution. The curvature can be described with a lens function, for example a two-dimensional freeform (e.g., described by a polynomial function) or it can be a biconic shape or a cylindrical shape (e.g., with a radius of curvature of about 1000-300 millimeters, such as about 500 mm). The curvature and the computed diffusor height profile can be designed so that the light path of all field points of the image projected on the hybrid reflecting IIS coming from the PGU match the required illumination in the eye box (the area where the driver/occupant's eyes should be located for observation of the virtual image). For example, this can allow a high efficiency of the system with a low light fall-off of the virtual image towards the sides (with significant reduction of vignetting) and a high perceived brightness and homogeneity all over the eye box. The hybrid reflective IIS can be based on deterministic scattering such as by using a tailored or otherwise computed reflective diffuser. The achromatic diffuser can be designed with low granularity to enable a brilliant and sharp virtual image. The feature sizes can then be very low and shallow. Starting from a regular structure that provides the right angular distribution (e.g., a micro lens array or a specific 2D wave structure), the specific pattern can then be computed, for example as described in U.S. Pat. No. 10,254,449. The reflective structure can provide a specific, e.g., rectangular, angular distribution with a high suppression of the retro-reflective component to avoid that light from the screen goes back in the projection unit. The reflective structure can improve sun-light resistance, since light coming from the sun in the reverse direction from the virtual image will be scattered and only a very small amount will go into the PGU. In some implementations the reflective lens function is recorded in a volume hologram providing a polymer film which only reflects the design wavelength for the HUD and transmits all other wavelengths which is further beneficial for sun load. In some implementations, the present subject matter can provide a windshield HUD system that has an improved field of view (FOV). For example, the FOV can be about 13×5 degrees. In some implementations, the present subject matter can provide a windshield HUD system that has reduced packaging volume. Having a hybrid reflecting IIS can be beneficial for packaging because the beam pass can be folded and the optical volume of the projection path can be reused. The packaging volume can be as small as about 14 liters also when the system provides significantly improved VID and/or FOV. For example, a VID of about 15 meters can be achieved, which can allow the driver/occupant to see HUD content with little or no refocusing. In the present subject matter, the sunlight may instead be focused on the hybrid reflecting IIS, which can improve sun load management. Only a small portion of the sunlight may actually reach the PGU. The system can provide better cooling and reduce the risk of thermal damage to the PGU. The present subject matter can provide an advantageously large image (e.g., about 60 millimeter by 100 millimeter, or 60×100 mm) on the intermediate plane, which also reduces glare issues and sun load impact compared to smaller image sizes. The area of the eye box can be advantageously increased. For example, an eye box of about 180×120 mm can be achieved. Further a windshield HUD having an IIS can support a better contrast and/or color gamut compared to TFT based systems.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons. A person traveling with the vehicle can be characterized as a driver and/or an occupant. For simplicity, the user of the systems described herein will be referred to as an occupant, regardless of whether the person performs any driving tasks with regard to the vehicle.

Examples described herein refer to a hybrid reflecting intermediate image screen. As used herein, a hybrid reflecting intermediate image screen is an image screen that is positioned intermediate between an image source (e.g., a picture generating unit) and a windshield of a vehicle. The term “hybrid” refers to an element which is derived by a combination of classical optical ray tracing optimization and a diffractive component, e.g. computed by an iterative Fourier transform algorithm (IFTA). The hybrid reflective intermediate image screen is characterized by at least a field correction term and a diffuser term. The field correction term can be calculated/optimized with classical sequential ray tracing to correct the direction of the light coming from the PGU that each point in the image screen illuminates the whole eye box and as little as possible light gets lost outside the eye box. Without this field correction term, the eyebox location and size would be different for each image point since the chief ray of the illumination coming from the PGU does not necessarily match the chief ray of the optical system which forms the virtual image. The field correction term can be characterized by a lens function, e.g. a two-dimensional freeform (e.g., described by a polynomial function) or it can be a biconic shape, where the surface z(x, y) is given by:

$$z = \frac{{c}_{x} {x}^{2} + {c}_{y} {y}^{2}}{1 + \sqrt{1 - ( 1 + {k}_{x} ) \cdot {c}_{x}^{2} {x}^{2} - ( 1 + {k}_{y} ) {c}_{y}^{2} {y}^{2}}} ,$$

$$where$$

$${c}_{x} = \frac{1}{{R}_{x}}$$

$$and$$

$${c}_{y} = \frac{1}{{R}_{y}} ,$$

where Rₓ and R_{y} is the respective radius of curvature in x and y, and cₓ and c_{y} are the conic constant in x and y. The field correction term can be a cylindrical shape where the surface z(x) is given by:

$$z = \frac{{x}^{2}}{R ( 1 + \sqrt{1 - \frac{{x}^{2}}{{R}^{2}}} )} ,$$

where R is the radius of curvature. The shape of the IIS and the corresponding field correction term contains the necessary angular shift of the beam to match the PGU illumination path to the HUD projection beam path. This typically results in a convex shape for the hybrid reflective IIS. The field correction term defines the physical carrier shape of the IIS where the diffuser structure is placed on top. The diffuser term can be computed to allow a tailored scattering of the light coming from the IIS. In some implementations, it can be computed as described in U.S. Pat. No. 10,254,449. The deterministic calculated diffuser allows a tailored scattering of the incoming, e.g., collimated light into a specific, e.g., rectangular angular distribution. The angular scattering distribution can be tailored to meet the necessary angular spread to match the necessary eye box illumination. This allows a high brightness/homogeneity and efficiency of the system and avoids light around the eye box. The calculated diffuser pattern is described as a 2D phase distribution Δφ(x, y), showing the necessary phase shift of the light to realize a certain angular scattering distribution. For a diffuser surface height profile with a reflective coating as outmost layer, the phase shift Δφ(x, y) can be realized by a special height profile h_{R} (x, y) which is calculated:

$${h}_{R} ( x , y ) = \frac{Δφ ( x , y ) \cdot λ}{2} ,$$

where λ is the design wavelength. The design wavelength can be the center wavelength of the illumination spectrum. As an example, using RGB LEDs for illumination purposes in the PGU, the center wavelength can be at 550 nm. The total height or corresponding phase shift is at least two and a half times the longest illumination wavelength used and the lateral structure sizes need to be greater than five times the longest illumination wavelength to allow a diffuser without significant disturbing color effects. The computed diffuser structure also minimizes the amount of the specular reflex coming from the diffuser. As an example, the specular reflex can be suppressed under 5% and is not visible as a peak in the total scattering distribution. This leads to a homogeneous eye box illumination and also reduces sun load and glare issues, because the rays coming in reverse direction through the optical system are scattered at the IIS and hardly any light can go to the PGU. The surface structure is continuous in both lateral directions having no steps or edges. The diffuser structure has a low perceived granularity to allow a sharp projection of the intermediate image. The diffusor surface pattern can consist of an arrangement of one or multiple computed unit cells. The arrangement can have any of multiple shapes, including, but not limited to, rectangular, or hexagonal. The transition between the different sub-cells can be computed so the sub-cells are continuous without any steps. Having multiple unit cells reduces potential grating and aliasing effects and perceived granularity. In some implementations, the field correction term can be described as phase shift and can be added to the diffuser phase shift. In this case the carrier shape can be flat having a surface profile derived out of filed correction phase term+ diffuser phase term on it.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

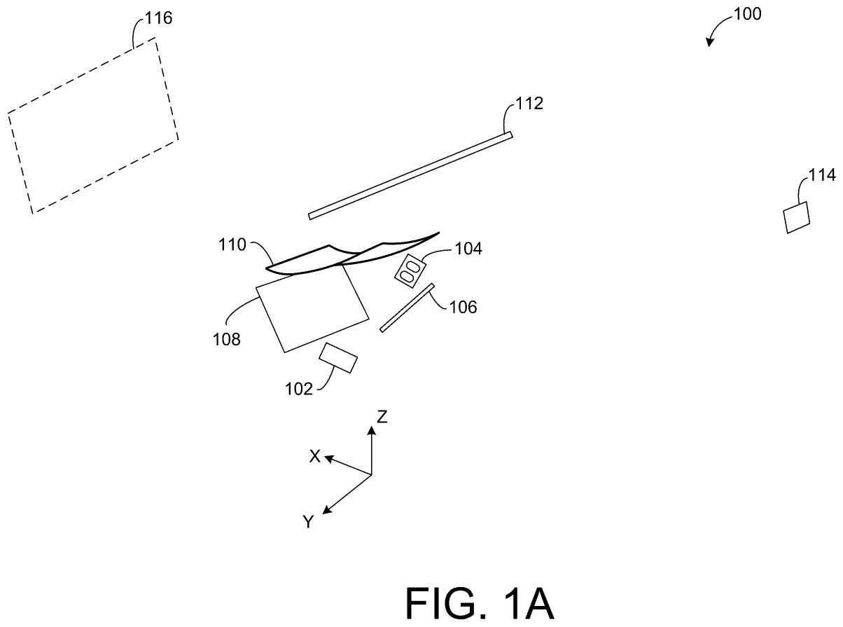

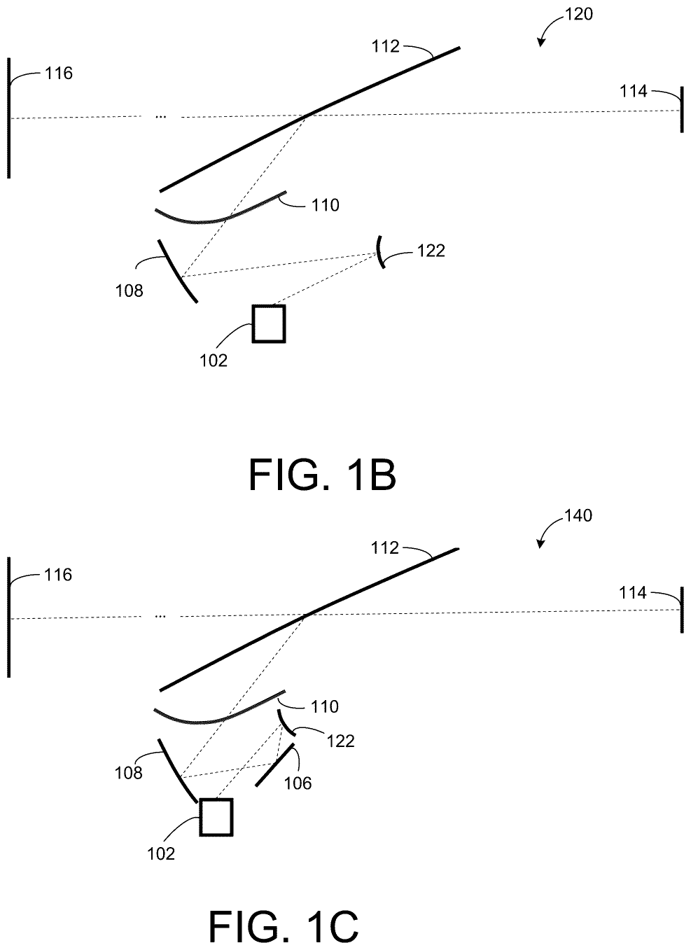

FIGS. 1A-1C show schematic examples of windshield HUD systems 100, 120, and 140, respectively. Any or all of the windshield HUD systems 100, 120 or 140 can be used with one or more other examples described elsewhere herein. The windshield HUD systems 100, 120 and 140 are schematically shown, and some components are omitted, or shown schematically, for simplicity. The windshield HUD system 100, 120 or 140 can be configured for installation in a vehicle, most of which is also omitted in the respective illustrations. Some features of the windshield HUD system 100, 120 and 140 will be described with reference to a Cartesian coordinate system, approximately oriented in FIG. 1A. The coordinate system indicates an x-direction (e.g., a direction along which the vehicle can travel), a y-direction (e.g., a direction across the vehicle from side to side), and a z-direction (e.g., a vertical direction with regard to the vehicle).

Beginning with FIG. 1A, the windshield HUD system 100 includes a PGU 102 that provides illumination and image content. The PGU 102 has a light source based on one or more illumination techniques. In some implementations, the PGU provides illumination using one or more LEDs. For example, LEDs of multiple colors (e.g., red, green, blue) can be provided. In some implementations, the PGU 102 can generate an image using a liquid crystal on silicon (LCOS) projector. One or more other approaches can be used, including but not limited to a digital micromirror device (DMD) and/or a microelectronic mechanical system (MEMS) projector. For example, the PGU 102 can use one or more optical elements, including but not limited to, a lens and/or mirror, between the light source and the LCOS/DMD/MEMS device, and/or elsewhere.

The windshield HUD system 100 includes a hybrid reflective IIS 104. The hybrid reflective IIS 104 can receive light from the PGU 102. The PGU 102 cannot produce the angular spread necessary to fill an eye box 114. Therefore, two things are needed. First, one needs the necessary spread to fill the size of the eye box 114. One can tailor the diffusor (e.g., with a non-stochastic microoptical computed surface height profile) placed on the surface of the hybrid reflective IIS 104 to make an, e.g., rectangular scattering profile. The non-stochastical computed diffuser increases the pupil area given by the PGU to the desired eye-box shape and size in which the virtual image 116 is visible to the driver. Using the hybrid reflective IIS 104, the virtual image 116 can be visible in a specific area, here the eye box 114, which can be shaped as necessary to, for example, allow different driver head positions (e.g., the eye box is rectangular shaped with a spread of 180×120 mm). Thus, the diffusor on the IIS surface can create, e.g., a rectangular spread to match a rectangular eye box. Still, if the hybrid reflective IIS 104 would be planar, the spread generated from the diffuser for different field points would not perfectly overlap in the eye box. This would result in a light falloff for higher fieldpoints for outer eye box positions. Or one would need to increase the total diffusor spread which would decrease efficiency and add more light in the outer area where it is not needed or even disturbing. Therefore one needs, second, a field correction term which determines the overall shape/curvature of the hybrid reflective IIS 104 to correct the chief (center) field angles. This results in the generated (rectangular) spread of all field points overlapping (ideally, perfectly) in the rectangular eye box. This way the brightness of the virtual image can be increased since the light is shaped to the eye box area needed. For example, the brightness can be greater than about 15000 candela per square meter. The surface structure can be defined or tailored according to a specified height profile.

The curvature can be a freeform and since the eye box 114 is typically rectangular shaped to allow all possible head positions, this requires an anamorphic optical lens function, e.g., a biconic or cylindrical lens term. The curvature and the resulting lens function incorporated in the IIS 104 can be designed so that the illumination light path of all field points of the image on the hybrid reflective IIS 104 of the light coming from the PGU 102 match the light path given by the HUD projection system towards the eye box to allow tailored illumination in the eye box 114, allowing a high efficiency of the system with a low light fall-off of the virtual image 116 towards the sides. Thus, the shape of the IIS 104 and the corresponding field correction term contains the necessary angular shift of the beam to match the PGU illumination path to the HUD projection beam path. This typically results in a convex shape for the hybrid reflective IIS 104. This leads to easier manufacturing and better surface quality in terms of granularity, since the necessary lens function would in general result in higher frequencies (small structure sizes) or higher depth of the microstructures.

The hybrid reflective IIS 104 being reflective can provide an advantage in reducing the volume of the package space required for the windshield HUD system 100 due to folding the beam and passing the volume at least twice. The hybrid reflective IIS 104 can have a curved carrier shape (with a one- or two-dimensional lens function, such as a biconic or a polynomial freeform (e.g., based on a Chebyshev polynomial)) or can have a cylindrical shape. It can be realized e.g., by a polymer with a reflective metal coating. As another example, the IIS 104 can have a plane carrier shape and the field correction phase term is added to the phase distribution of the diffuser term. The resulting phase term is than transferred in a diffuser surface height profile which can be added on top of the carrier shape. As another example, the hybrid reflective IIS 104 can be realized as a curved or plane volume holographic polymer element. This transparent polymer can be realized so that it only reflects the required lens function for the design wavelength (e.g., the specific spectrum of the RGB LEDs used in the PGU).

The windshield HUD system 100 can include a mirror 106. The existence and position of the mirror 106 depends strongly on the optical specifications and the given package volume. In the shown windshield HUD system 100, the mirror 106 is a plane/flat folding mirror to tailor the beam path within its given package volume and reduce the overall necessary volume of the windshield HUD system 100. The mirror 106 may have no optical power and can serve to fit the package. The mirror 106 can receive light scattered from the hybrid reflective IIS 104 having a lens function. The mirror 106 can include any substrate having reflective properties that allow sufficient light originating at the PGU 102 to be reflected. For some applications, the mirror 106 can be characterized as a freeform mirror. For example, the mirror 106 can have a lens function (e.g., biconical, spherical, aspherical or freeform, e.g., based on a polynomial description (e.g., a Chebyshev polynomial)). For example, a freeform surface can be described by a base radius of curvature and a sequence of Chebyshev polynomials. The mirror 106 can contain coatings to improve efficiency, color, stray-light/sun-light suppression or contrast. E.g., the mirror 106 can have a cold mirror coating allowing only rays under a certain wavelength threshold to get reflected. Longer wavelength, e.g., infrared light from the sun will be transmitted and can be placed on an absorber. Further, coatings improving the reflectivity can be used. Further, a polarization film (e.g., a waveplate or polarizer) can be placed on the mirror to improve contrast or suppress stray light (e.g., sun light).

The windshield HUD system 100 includes a freeform mirror 108 that can either receive light reflected from the mirror 106 or directly receive scattered light from the hybrid reflective IIS 104, in case mirror 106 is not existent. The freeform mirror 108 can include any substrate having reflective properties that allow sufficient light originating at the PGU 102 to be reflected. The freeform mirror 108 acts as magnifier and compensates the shape of the windshield; as such, the freeform mirror 108 can have a lens function (e.g., biconical, spherical, aspherical or freeform, such as based on a 2D polynomial). For example, a freeform surface can be described by a base radius of curvature and a sequence of Chebyshev polynomials. The mirror 106 and/or the freeform mirror 108 can contain one or more of the same or different coatings to improve efficiency, color, stray-light/sun-light suppression or contrast. For example, if the windshield HUD system 100 includes the mirror 106, the coating(s) can preferably be placed on the mirror 106.

The windshield HUD system 100 includes a cover 110 used as a glare trap. For example, the cover 110 is made of transparent polymer material. The cover 110 that in part forms the glare trap can have a specific shape designed to avoid glare issues from sunlight in the windshield HUD system 100. For example, the shape can be such that any light arriving from the outside hitting the cover 110 does not reach the eye box of the occupant. The cover 110 can be positioned between the freeform mirror 108 and a windshield 112 of the vehicle. The cover 110 can contain one or more coatings to improve efficiency, color, stray-light/sun-light suppression and/or contrast. E.g., the cover 110 can have a hot mirror coating allowing only rays under a certain wavelength to pass the cover. E.g., infrared light from the sun will be reflected. Coatings improving the transmittivity can be used. A polarization coating/film (e.g., a waveplate or polarizer) can be placed on the mirror to improve contrast or suppress stray-light (e.g. sun-light).

The windshield HUD system 100 can project light that when reflected by the windshield 112 and then observed by the occupant creates the appearance of a virtual image 116 for the occupant. The virtual image 116 can be characterized as being located at a VID from the eye box 114. The VID can be about 10-30 meters. For example, the VID can be about 15 meters. Having a significant VID can be beneficial to allow the occupant to see the content generated by the windshield HUD system 100 (i.e., the virtual image 116) with no or only minor refocusing from observing objects in traffic or otherwise near the vehicle. This can allow the virtual image 116 to practically blend into the surroundings from the occupant's perspective. Another advantage with having a VID greater than about 10 m is that the virtual image 116 may not be perceived by the occupant as a double image because the windshield 112 is relatively close to the pupil zone of the eye box 114 (i.e., to the occupant) compared to the VID distance.

The virtual image 116 can be characterized in terms of a FOV relative to the occupant. The FOV can be specified using a horizontal angle and a vertical angle. In some implementations, the horizontal angle can be about 10-20 degrees, for example about 13 degrees. In some implementations, the vertical angle can be about 3-10 degrees, for example about 5 degrees. Having a wide FOV can facilitate presentation of augmented reality (AR) content by the windshield HUD system 100. For example, the AR content can highlight or otherwise represent pedestrians, house numbers, and/or street signs. Particularly, achieving a wide FOV at the same time as a great VID can present challenges with regard to package space and/or the obtainable brightness regarding available PGU technologies.

The windshield HUD system 100 has a folded beam path for the light going from the PGU 102 to the hybrid reflective IIS 104 to the mirror 106 to the freeform mirror 108, and reuses the same optical volume between the mirror 106 and the freeform mirror 108. This can be made possible, in part, because the PGU 102 can project (e.g., through an aperture in the housing) toward the hybrid reflective IIS 104, and this optical volume is also traversed by light propagating from the mirror 106 toward the freeform mirror 108. That is, this package space can be reused because the same optical volume is doubly used, which reduces the package space and makes the windshield HUD system 100 more compact. That is, some or all of the hybrid reflective IIS 104, and the mirror 106 and the freeform mirror 108, can be curved, and folded relative to each other (beam folding), to minimize the package space. For example, the mirror 106 can face away from the occupant, and the freeform mirror 108 can face toward the occupant. As another example, the freeform mirror 108 can be positioned forward of the mirror 106 relative to an x-direction of the vehicle coordinate system.

In general, a HUD system needs at least a PGU (which can provide the picture itself already as for TFT with back illumination) and a magnifier lens (mirror) which also compensates the windshield shape as well. FIG. 1B shows an example of the windshield HUD system 120 as including the PGU 102; a hybrid reflective IIS 104 In FIGS. 1B and 1C the cylindrical convex shape of the IIS 104 is highlighted. The radius is not true to size. the freeform mirror 108, the cover 110, and the windshield 112. The PGU 102 can generate light (i.e., one or more images) that impinge on, and are reflected and diffused by, the hybrid reflective IIS 104. The freeform mirror 108 receives light from the hybrid reflective IIS 104 and reflects it through the cover 110 and toward the windshield 112. The windshield 112 reflects light from the freeform mirror 108 so that the reflected light is visible to an occupant at the eye box 114. To the occupant, the light reflected by the windshield 112 appears as a virtual image 116 that is positioned in VID ahead of the eye box 114 position. That is, the windshield HUD system 120 omits at least the mirror 106 compared to the windshield HUD system 100.

FIG. 1C shows an example of the windshield HUD system 140 as including the PGU 102; the hybrid reflective IIS 104 that is curved; the mirror 106; the freeform mirror 108, the cover 110, and the windshield 112. That is, in the present subject matter the hybrid reflective IIS 104 can be flat or curved. The PGU 102 can generate light (i.e., one or more images) that impinge on, and are reflected and diffused by, the hybrid reflective IIS 104. The mirror 106 receives light from the hybrid reflective IIS 104. The freeform mirror 108 receives light from the mirror 106 and reflects it through the cover 110 and toward the windshield 112. The windshield 112 reflects light from the freeform mirror 108 so that the reflected light is visible to an occupant at the eye box 114. To the occupant, the light reflected by the windshield 112 appears as a virtual image 116 that is positioned In VID ahead of the eye box 114 position.

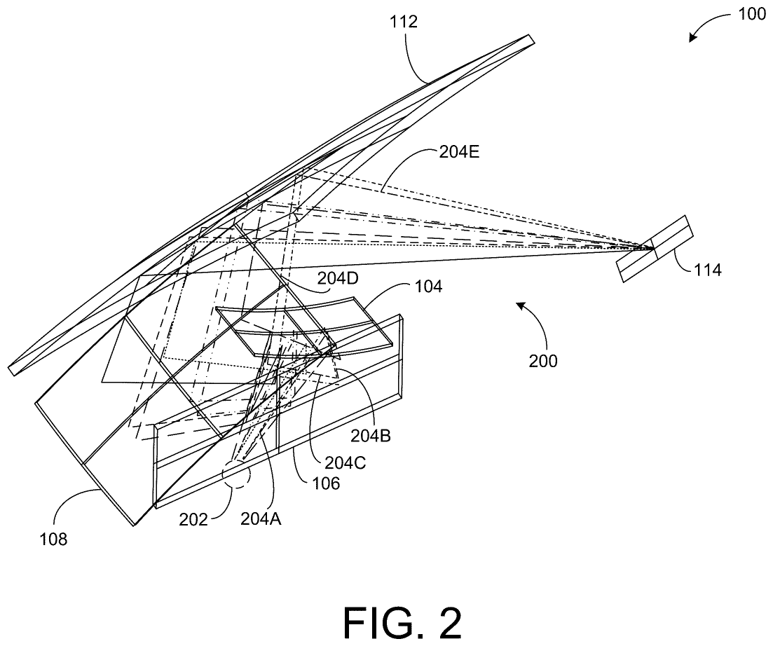

FIG. 2 shows an example of light paths 200 in the windshield HUD system 100 of FIG. 1A. The light paths 200 can be used with one or more other examples described elsewhere herein. The light paths 200 represent chief rays for different field points. For example, this can include the outer corners of the virtual image 116 (i.e., maximum angles) and center. The hybrid reflective IIS 104 and the mirror 106 and the freeform mirror 108 are here shown in relation to a location 202 (schematically illustrated) where the PGU 102 introduces light.

As mentioned, the hybrid reflective IIS 104 can have a special computed curvature. With a rectangular eye box to allow all possible head positions, an anamorphic optical lens function is used (e.g., a biconic). In some implementations, the hybrid reflective IIS 104 has a radius of curvature (ROC) of about plane to 300 mm in one direction and plane to about 300 mm in the other direction. For example, the ROC can be about 500 mm in the one direction and plane in the other direction resulting in a cylindrical carrier shape of the IIS 104. A ROC such as those exemplified above can avoid that light falls off towards the side/edge of the virtual image. This ROC can be computed based on the rest of the windshield HUD system 100 to fit the optical design. In some implementations, the ROC can be designed to match the aperture of the PGU 102 (e.g., at the location 202). For example, this can enable high brightness for higher field points (e.g., at greater angles). The ROC can provide an optimal illumination path from the aperture of the PGU 102. The size of the hybrid reflective IIS 104 can be about 40-150 mm horizontally and about 20 to 80 mm vertically. For example, the hybrid reflective IIS 104 can have a size of about 85×45 mm. The hybrid reflective IIS 104 can provide better cooling regarding sun load. Regarding sun load a small amount might enter the windshield HUD system 100 under an angle where the virtual image is situated going on a reverse light path back to the hybrid reflective IIS 104. This amount of light will be further scattered when hitting the hybrid reflective IIS 104 keeping the amount of light reaching the PGU 102 very low, thereby reducing the risk of introducing stray light visible as glare for the driver and, as a worst case, thermal damage to the PGU 102. The windshield HUD system 100 can provide (on the hybrid reflective IIS 104) a larger intermediate image which reduces the necessary amount of magnification to generate the final virtual image. A lower magnification of the system reduces issues regarding sun load, glare and visible granularity.

The illustration shows multiple chief rays each propagating from the location 202 (i.e., the exit surface from the PGU 102) to the hybrid reflective IIS 104, from there to the mirror 106, from there to the freeform mirror 108, from there to the windshield 112, and from there to the eye box 114. For simplicity, the propagation of one of these chief rays will be described.

The chief ray can include a light path 204A from the location 202 to the hybrid reflective IIS 104. The hybrid reflective IIS 104 can have a convex shape facing the origin of the light path 204A (e.g., facing the location 202). The origin of the light path 204A (e.g., the location 202) can be located below the mirror 106 and the freeform mirror 108 in the z-direction of the vehicle coordinate system. The origin of the light path 204A (e.g., the location 202) can be located between the mirror 106 and the freeform mirror 108 in the x-direction of the vehicle coordinate system. The origin of the light path 204A (e.g., the location 202) can be located below the hybrid reflective IIS 104 in the x-direction of the vehicle coordinate system. The chief ray can include a light path 204B from the hybrid reflective IIS 104 to the mirror 106. The chief ray can include a light path 204C from the mirror 106 to the freeform mirror 108. The light path 204C intersects the light path 204A. For example, the light paths 204A and 204C occupy the same point in space within the optical volume of the windshield HUD system 100. The chief ray can include a light path 204D from the freeform mirror 108 to the windshield 112. The chief ray can include a light path 204E from the windshield 112 to the eye box 114.

The above examples illustrate that a head up display system (e.g., the windshield HUD system 100) can include: a picture generating unit (e.g., the PGU 102) comprising a light source, the picture generating unit generating light for the head up display system in a first light path (e.g., the light path 204A); a hybrid reflecting intermediate image screen (e.g., the hybrid reflective IIS 104) that receives the light from the picture generating unit; a first mirror (e.g., the mirror 106) that receives the light, after scattering at the hybrid reflecting image screen, in a second light path (e.g., the light path 204B); and a second mirror (e.g., the freeform mirror 108) that receives the light, after reflection at the first mirror, in a third light path (e.g., the light path 204C). The third light path intersects the first light path, and at least one of the first or second mirror is curved.

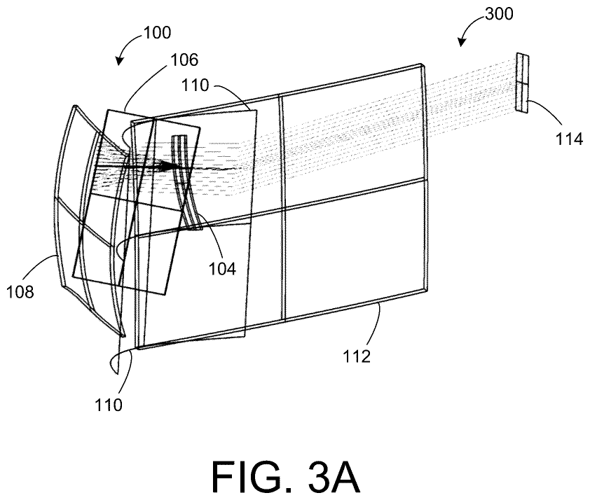

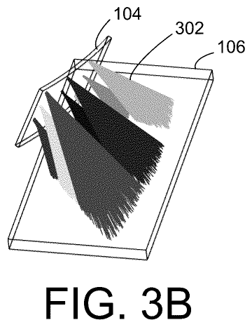

FIG. 3A shows another example of light paths 300 in the windshield HUD system 100 of FIG. 1A. The light paths 300 can be used with one or more other examples described elsewhere herein. The windshield HUD system 100 is here shown from a different angle, and with additional exemplary details The windshield HUD system 100 can be tailored (e.g., optimized) by using an instance of the windshield 112 that has a wedge-shaped profile, and/or by providing the windshield 112 with one or more polarization coatings.

The light paths 300 may originate at a PGU (e.g., the PGU 102 in FIG. 1A), which is not shown in this figure for simplicity. Rather, in this illustration the light paths 300 are shown from the point where they are scattered by the hybrid reflective IIS 104. It exemplifies the outgoing beam path/bundle from one field point coming from the IIS 104 towards the eye box 114. The shape and the diffusive character of the IIS 104 enables the ray bundle coming from the IIS having the required size and shape to (ideally) entirely fill the eye box 114. Coming form the IIS, the light, is reflected, in turn, by the mirror 106, the freeform mirror 108, and the windshield 112, while also traveling through the cover 110. The scattering ensures that the area of the eye box 114 is filled up with the light paths 300. By contrast, FIG. 2 does not show the scattering, which is why that illustration shows all rays meeting in a small spot in the pupil plane of the eye box.

FIG. 3B shows an example of a rectangular diffusor spread for the hybrid reflective IIS 104 of FIG. for a couple of field points. 3A. A number of light bundles 302 are shown to begin at the hybrid reflective IIS 104 and arrive at the mirror 106, whereas the rest of the windshield HUD system is here omitted for clarity.

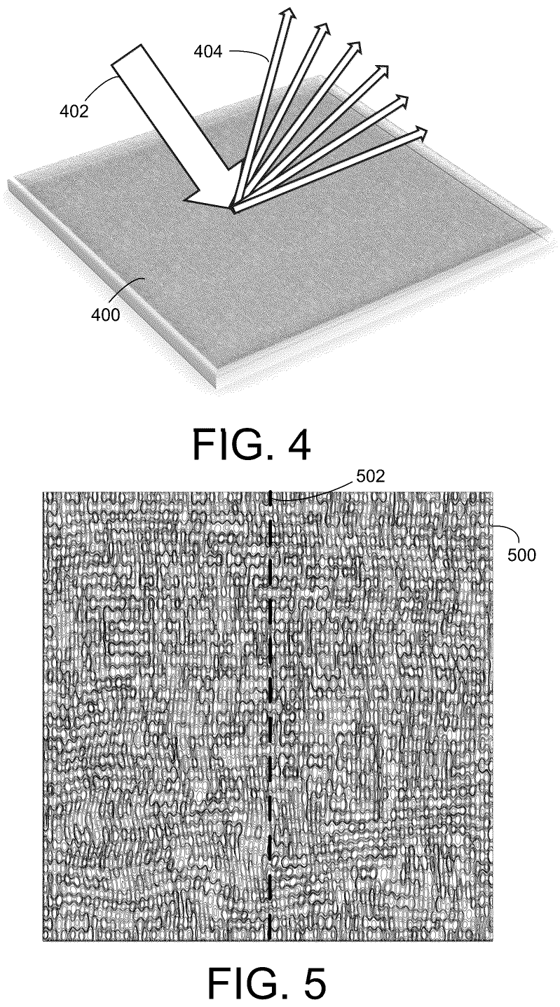

FIG. 4 shows an example of a section of an achromatic diffuser area 400 that can be used with windshield HUD systems described herein. This illustration shows multiple repetitions of a unit cell. The achromatic diffuser area 400 can be part of a component such as the hybrid reflective IIS 104 and can therefore be placed on a carrier geometry given by the field correction term of the IIS. In some implementations, the carrier geometry contains a curvature (e.g., with a specific ROC). In some implementations the carrier geometry can be plane geometry and the field correction phase term is already integrated in the diffuser optical function. Rays 402 are incoming from a PGU, and scattered light 404 comes from the achromatic diffuser area 400. The rays 402 and the scattered light 404 are here schematically illustrated as respective arrows.

The unit cells of the achromatic diffuser area 400 can have a size depending at least in part on the total angular distribution (shape of the eye box) and angular resolution needed and from the perceived granularity. For example, having a too small unit cell can result in grating effects (seeing color effects). For example, the unit cell of the achromatic diffuser area 400 can have a side of about 250 microns to 5 mm, such as about 1 mm. The features sizes (e.g., the size from one hill like structure) is about 1 to 100 microns and the total max structure depth is about 0.5 to a few microns. The surface profile is not stochastic, but rather has a determined structure. The surface structure is continuous in both lateral directions having no jumps, steps or edges. The first derivative of the surface height function should be continuous. The deterministic micro-structure can be computed e.g., as described in for example as described in U.S. Pat. No. 10,254,449. The structure is designed in a way that the unit cell can be periodically repeated in both lateral directions. To avoid granularity and different unit cells having the same boundary conditions (to enable a smooth transition from one unit cell to the other) can be calculated and placed randomly on the diffuser surface. The diffuser including multiple instances of the unit cell is configured for its optical purpose of providing a reflective surface that scatters light to form a specific size and homogeneity of the illumination in the eye box.

The achromatic diffuser area 400 can be formed on any of various substrates, including but not limited to, metal, composite, polymer, or glass or a combination of listed materials. For example, the surface structure can be formed as one or more layers or coatings on the surface. The achromatic diffuser area 400 is reflective, so an outermost layer of the surface structure can be a reflective material such as a metal. The structure can be a microoptical computed surface profile having a microstructure pattern. The surface structure can be formed using any of multiple technologies, including but not limited to wafer or roll-to-roll processes including lithography, etching, imprinting, embossing, molding, or coating technologies. For example, a wafer process means that the lithography step (e.g., gray scale lithography) is done on a wafer (having a polymer resist on top) using a specialized machine. For example, gray scale laser lithography can be used. In some implementations, gray scale lithography (e.g., with electron beam lithography, laser writing or LED gray scale lithography) can be used to generate the master structure which can be copied and transferred to generate sub masters out of polymer (e.g., silicone) or metal (e.g., nickel or steel). Using those sub-masters, the structure can be copied into a polymer or plastic (e.g., by embossing, imprinting or compression or injection molding). Afterwards, the structure can be coated, e.g., with a high reflectivity metal coating or a combination of metal and dielectric layers. In another implementation, on a curved carrier mirror a structured polymer layer can be added which contains the specific height profile for the transparent computed diffuser.

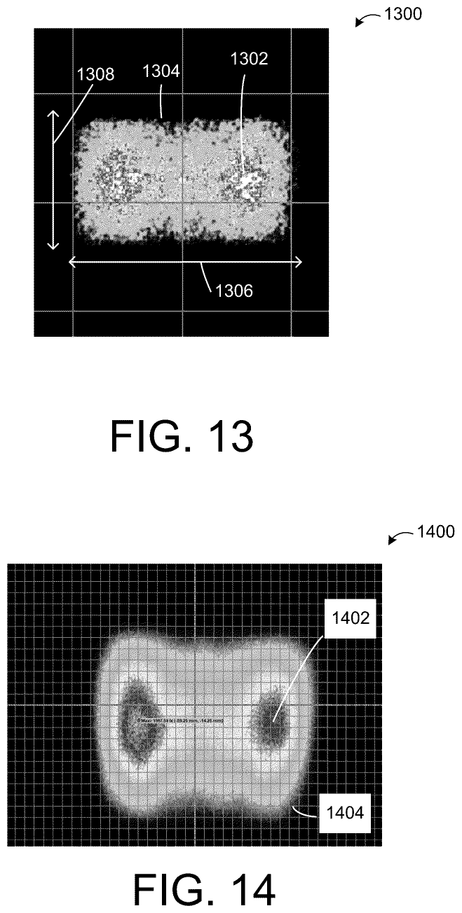

Further, the necessary optical function can be implemented in a curved or plane holographic volume diffusor film. A volume holographic optical element (VHOE) can be used to only reflect the design wavelength, e.g., 633 nm, 532 nm and 457 nm. While the VHOE reflects light of the design wavelengths (in Bragg Condition), the VHOE is transparent for all other wavelength (off-Bragg condition). This allows superior performance for sun light suppression, since the sun light has a broad spectrum and only light of the design wavelength is reflected, the main sun load will pass the VHOE and land on the absorber. The photopolymer film can be applied directly on the curved or plane surface of the IIS. The combined optical function containing field correction term and the diffuser term can be recorded in the photopolymer by holographic interference lithography. Here the necessary scattering profile (e.g., a homogenous scattering in a rectangular angular intensity distribution as in FIG. 13) is created by an external setup creating such an angular distribution (e.g., generated by a collimated coherent source, e.g. pulsed laser, +diffuser) and then copied for all design wavelength by holographic recording into the photopolymer. Another way is to copy the diffuser function with contact copying method into the photopolymer. Here a master diffuser is generated by a writing process/lithography process (e.g., gray scale lithography, e-beam lithography, or another lithography process). This master gets in a defined position towards the VHOE photopolymer film (later replica/copy) (normally almost contact) allowing that the optical phase function of the master is copied into the photopolymer film. This recording process is done for all design wavelength (e.g., with a pulsed laser/coherent source with suitable pulse dosage).

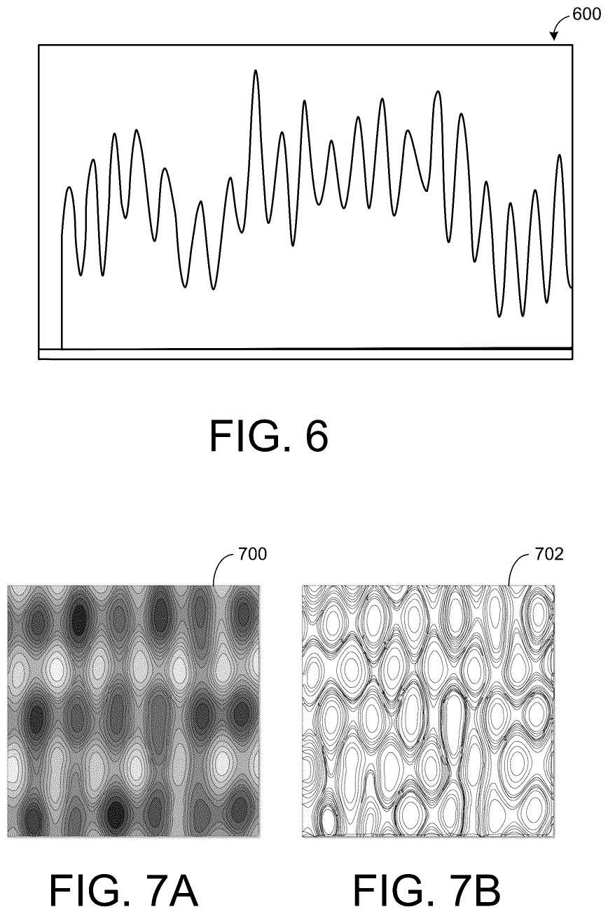

FIG. 5 shows an example of a non-stochastic microoptical computed unit cell 500 that can be used to form diffusers described herein. FIG. 6 shows an example of a height profile 600 taken along a line 502 of the non-stochastic microoptical computed unit cell 500 of FIG. 5. The height profile 600 can be used with one or more other examples described elsewhere herein. The non-stochastic microoptical computed unit cell 500 is the smallest unit that does not show any repetition. For example, for a grating the unit cell is one grating period. The height profile 600 has a non-stochastic pattern of local maxima and minima that can make the non-stochastic microoptical computed unit cell 500 a diffused smooth surface. The non-stochastic pattern can be contrasted with, say, a graining, which typically has a random/stochastic structure. FIGS. 7A-7B show the same (magnified) section of an area out of the unit cell 500 from FIG. 5 in examples 700 and 702, respectively, in two different ways to highlight the specified computed surface profile. Each of the examples 700 and 702 shows the different heights of the surface. In the example 700, the height is indicated using shading, where light (e.g., white) shading corresponds to low (e.g., down to zero) height and dark (e.g., black) shading corresponds to greater (e.g., up to a maximum) height. For example, the shape of each of the examples 700 and 702 can resemble that of a distorted egg container. That is, a hybrid reflective IIS (e.g., the hybrid reflective IIS 104) can be characterized by at least i) a field correction term that defines a carrier shape of the hybrid reflective IIS and ii) a diffuser term that defines a surface structure on the hybrid reflective IIS. The surface structure has no steps, jumps or edges in both lateral directions. Moreover, a first derivative of a surface height function is continuous.

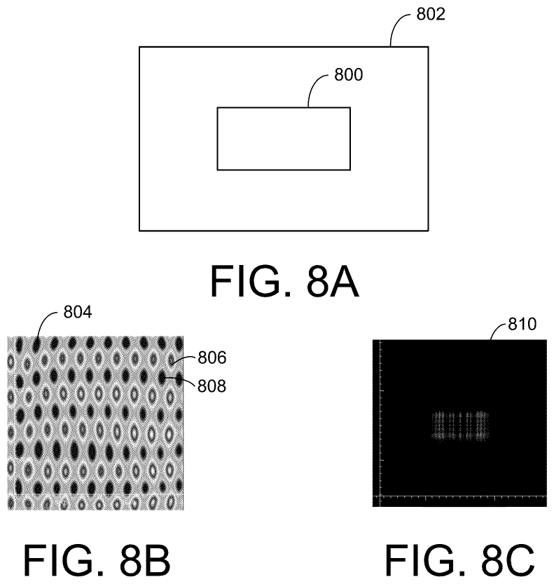

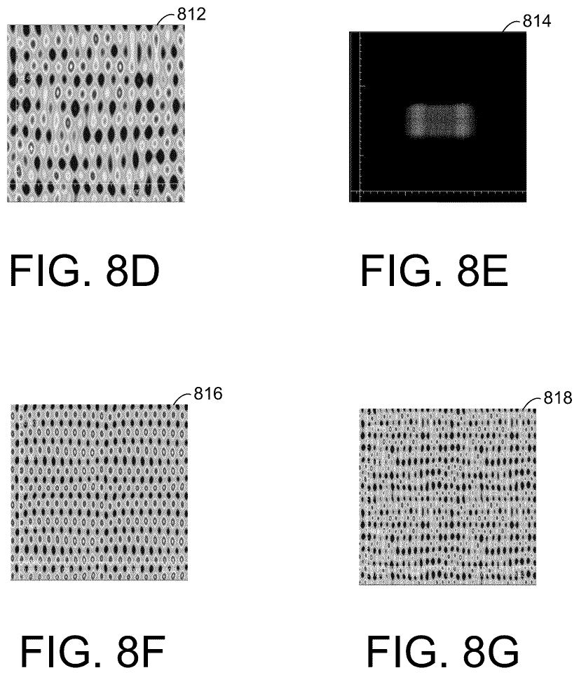

FIGS. 8A-8G show examples of how a reflective structure can be calculated and assembled. FIG. 8A shows an example of defining a scattering profile in form of a target eye box 800. The target eye box 800 can be defined relative to an area 802. For example, the area 802 can include a coordinate system with axes defining a height and width of the target eye box 800 at a certain position of the driver, and the scattering profile can then be computed in angular coordinates. In another example, the area 802 can include a coordinate system with axes defining the angular spread of the target eye box 800, showing the maximum angles necessary for the diffuser spread.

The reflective surface profile can be defined so that the height difference between the lowest and highest point of the surface profile introduces a phase shift in reflection which is greater than two and a half times the longest wavelength used. The lateral extensions can be about at least five times the longest wavelength used. The structure of the unit cell can be derived by first computing a start distribution with a certain wave structure which is generating the necessary angle spread of the diffuser, but still has issues regarding grating effects (resulting in color effects).

FIG. 8B shows an example of a height function 804. The height function 804 shows different heights of the surface using shading. For example, a shading 806 can correspond to a great (or small) height and a shading 808, different from the shading 806, can correspond to a small (or great) height. The height function 804 defines different heights across the surface of a unit cell. For example, the height function 804 can be a start height function in forming a continuous height profile. The start distribution can be derived by a specific randomization of a regular pattern. The start function is made in a way that when placed next to each other in any direction, the height profile is still continuous, showing no abrupt steps in the height profile.

The height function 804 can produce a scattering profile 810 as exemplified in FIG. 8C. The scattering profile 810 can show the behavior of the grating formed according to the height function 804. For example, the scattering profile 810 can be compared with the target eye box 800 to evaluate the light distribution.

FIG. 8D shows an example of a height function 812 that can be obtained after performing a special iterative Fourier transform algorithm (IFTA) (as described in U.S. Pat. No. 10,254,449) on the function 804. The height function 804 shows different heights of the surface using shading and differs from the height function 804 in various ways. For example, the height function 812 can be a final height function in forming a continuous height profile. The final structure provides a homogeneous scattering distribution.

The height function 812 can produce a scattering profile 814 as exemplified in FIG. 8E. The scattering profile 814 can show the behavior of the grating formed according to the height function 812. For example, the scattering profile 814 can be compared with the target eye box 800 to evaluate the light distribution.

Instances of the height function 804 and/or the height function 812 can be placed or repeated next to each other in multiple directions to form a continuous height profile within the required diffuser area. The computed cells can be placed next to each other and form a continuous surface profile. Multiple N (e.g., N=1 to 1000) of those structures can be computed using while keeping the interface in between the cells the same to allow a continuous height profile without steps when placing them next to each other. The arrangement can have any of multiple shapes, including, but not limited to, rectangular, or hexagonal. FIG. 8F shows an example of a continuous height profile 816 formed by placing instances of the height function 804 next to each other. FIG. 8G shows an example of a continuous height profile 818 formed by placing instances of the height function 812 next to each other.

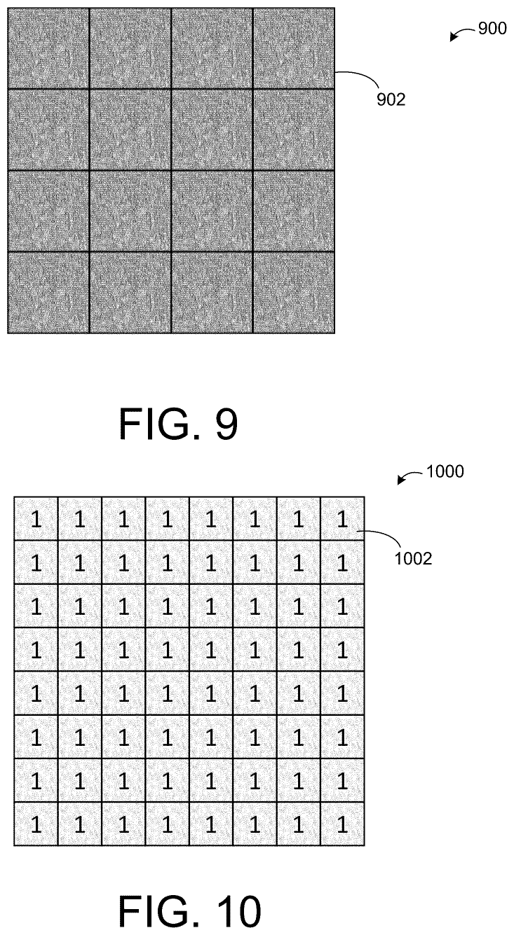

FIG. 9 shows an example of a diffuser area 900. The diffuser area 900 can be used with one or more other examples described elsewhere herein. The diffuser area 900 can be made using multiple unit cells 902. In some implementations, the unit cells 902 can be arranged in a grid pattern (e.g., in a 4×4 grid as shown, or in another pattern). For example, each of the unit cells 902 can include an instance of the non-stochastic microoptical computed unit cell 500 in FIG. 5). The unit cells 902 can satisfy periodic boundary conditions.

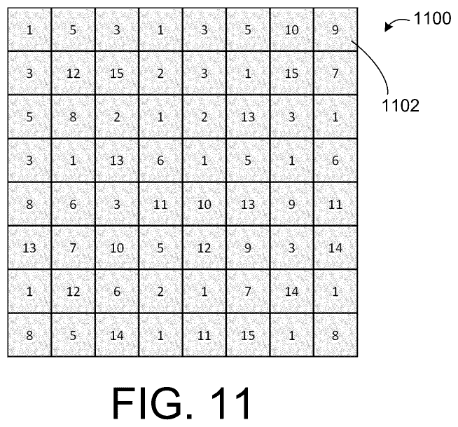

FIGS. 10-11 show examples of diffusor arrangements 1000 and 1100 that can be formed from unit cells. The diffusor arrangement 1000 is here formed of unit cells 1002 that are all identical to each other (i.e., only a single unit cell is used for the diffusor arrangement 1000). For example, the unit cell 902 in FIG. 9 can be used as each of the unit cells 1002.

The diffusor arrangement 1100 is here formed of unit cells 1102 that are not all identical to each other. The different numbers marked in the unit cells 1102 indicate the different types of the unit cells. A continuous profile of different sub-cells can be used. For example, the profile can be calculated so that the boundaries are continuous and have no step.

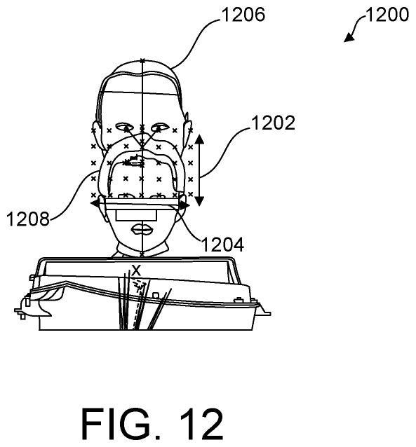

FIG. 12 shows an example of a diffusor specification 1200 regarding an eye box size and position. In some implementations, the diffusor specification 1200 can specify a height 1202 and a width 1204. For example, the diffusor specification 1200 can ensure that the eyes of both a taller person 1206 and a shorter person 1208 are within the defined eye box.

FIG. 13 shows an example of an angular intensity distribution 1300 in the farfield for the non-stochastic microoptical computed unit cell 500 of FIG. 5. The intensity distribution 1300 can be used with one or more other examples described elsewhere herein. The intensity distribution 1300 is shown in a graph where the horizontal and vertical axes represent angles according to an arbitrary unit (e.g., degrees). The intensity distribution 1300 shows different light intensities using shading. For example, a shading 1302 can correspond to a high intensity and a shading 1304, different from the shading 1302, can correspond to a low intensity. For example, the specular reflected part of the incoming ray 402 from FIG. 4 can correspond to the center of illumination of the intensity distribution 1300. The intensity distribution 1300 can be generated when light from the PGU 102 impinges on the hybrid reflective IIS 104 in the optical system. The intensity distribution 1300 can match the eye box 114 (e.g., FIG. 1A) so that the windshield HUD system projects its light in a most efficient presentation of image content to the occupant. The surface structure of the unit cell (see, e.g., the multiple unit cells in the achromatic diffuser area 400 in FIG. 4) can therefore be calculated so that the intensity distribution 1300 fits the eye box 114 and not a lot of light is present outside this eye box. The angular spread of the intensity distribution 1300 can have any shape (e.g., rectangular). With reference to FIG. 1A, the angular spread of the diffusor for a HUD system depends on the magnification of the image on the hybrid reflective IIS 104 relative to the virtual image in the eye box 114. Horizontally, it can be, e.g., 10-50 and vertically e.g., 5 to 30 degrees. In some implementations, in a horizontal direction the intensity distribution 1300 has a spread 1306 of almost 35 degrees, and in a vertical direction the intensity distribution 1300 has a spread 1308 of almost 18 degrees. Accordingly, a diffusor spread can be about 35×18 degrees.

FIG. 14 shows an example of an irradiance 1400 at an eye box position. The irradiance 1400 is shown in a graph where the horizontal and vertical axes represent lengths (e.g., width and height) according to an arbitrary unit (e.g., mm). The irradiance 1400 shows different light irradiances using shading. For example, a shading 1402 can correspond to a high irradiance and a shading 1404, different from the shading 1402, can correspond to a low irradiance.

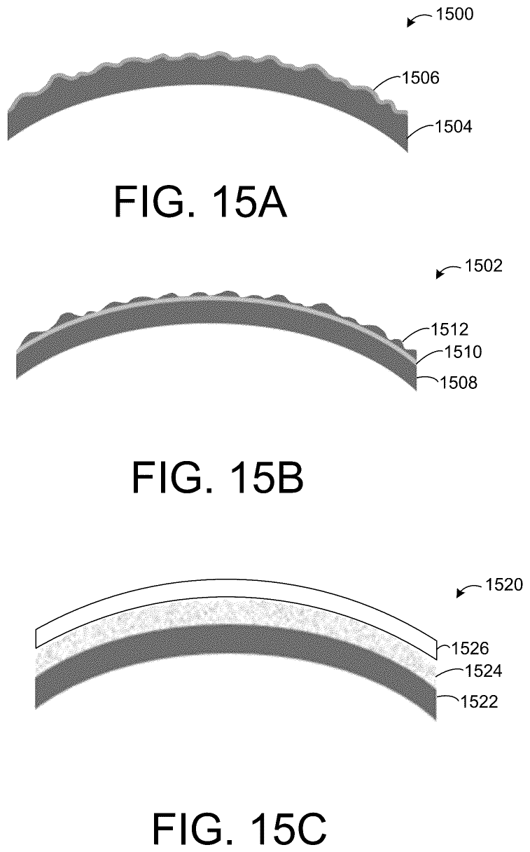

FIGS. 15A-15C show examples of hybrid reflective IISs 1500, 1502 and 1520, respectively. Any or all of the hybrid reflective IISs 1500, 1502 and 1520 can be used with one or more other examples described elsewhere herein. Only a portion of the respective hybrid reflective IIS 1500, 1502 and 1520 is shown. The curvature shown is used for illustrative purposes only. Each of the hybrid reflective IISs 1500, 1502 and 1520 is characterized by at least a field correction term and a diffuser term.

The hybrid reflective IIS 1500 includes a body 1504 and an outer surface 1506. The body 1504 is shaped with the height profile defining the surface structure of the hybrid reflective IIS. For example, the body 1504 is made from plastic material or another polymer. In some implementations, the outer surface 1506 can be a high reflectivity layer. The outer surface 1506 can conform to the shape of the body 1504 and therefore present a reflective surface having the height profile. For example, the outer surface 1506 can include a metal coating or a combination of metal and dielectric layers. The diffuser structure height profile h_{R} (x, y) in case of an outer surface metal coating can be calculated from the computed diffuser phase profile Δφ(x, y) using:

$${h}_{R} ( x , y ) = \frac{Δφ ( x , y ) \cdot λ}{2} ,$$

where λ is the design wavelength.

The hybrid reflecting IIS 1502 includes a body 1508, a reflective mirror 1510, and an outer surface 1512. The body 1508 can include a curved substrate (e.g., having a smooth surface). The reflective mirror 1510 includes a reflective material that can be applied onto the body 1508. The outer surface 1512 can include a polymer microstructure against the reflective mirror 1510. For example, the outer surface 1512 can be a structured polymer layer that provides the specific height profile for the transparent computed diffuser. The diffuser structure height profile hₚ(x, y) in case of a structured polymer layer on a metal layer can be calculated from the computed diffuser phase profile Δφ(x, y) using:

$${h}_{P} ( x , y ) = \frac{Δφ ( x , y ) \cdot λ}{Δ n \cdot 2} ,$$

where λ is the design wavelength and Δn the difference of the refractive indices between the material of the element (e.g. polymer or plastic) and of the environment.

In some implementations, the necessary optical function can be implemented in a curved or plane holographic volume diffusor film. For example, this can be done by holographic interference lithography, or by contact copying an existing diffusor master into the holographic volume diffusor film. FIG. 15C shows an example of the hybrid reflective IIS 1520 which is a volume holographic optical element. The hybrid reflective IIS 1520 includes a curved substrate 1522 and a photopolymer film 1524 against the curved substrate 1522. The curved substrate 1522 can include a transparent carrier film. For example, the transparent carrier film can include polycarbonate and/or polyethylene. The hybrid reflective IIS 1520 can include a cover layer 1526 positioned against an opposite side of the photopolymer film 1524 than where the carrier substrate 1522 is positioned. For example, the cover layer 1526 can include polyethylene. A contact copy process can be used as a way to mass produce the hybrid reflective IIS 1520.

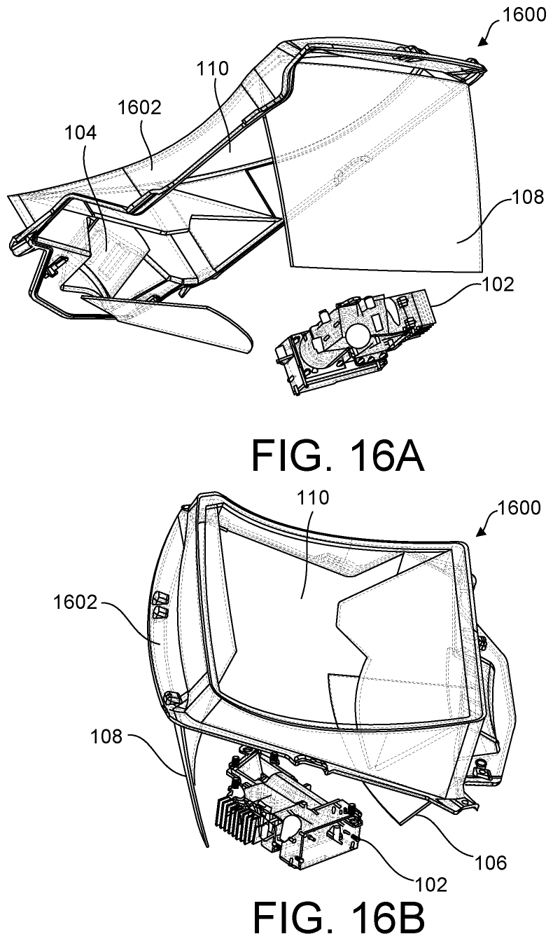

FIGS. 16A-16B show an example of a windshield HUD system 1600. The windshield HUD system 1600 can be used with one or more other examples described elsewhere herein. The windshield HUD system 1600 has a housing 1602. For example, the housing 1602 can include a bezel for stray light reduction. The windshield HUD system 1600 can include, with reference also to FIG. 1A or FIG. 1C, the PGU 102, the hybrid reflective IIS 104, the mirror 106, the freeform mirror 108, and the cover 110.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A windshield head up display system for an occupant of a vehicle, the windshield head up display system comprising:
a picture generating unit comprising a light source, the picture generating unit generating light for the head up display system in a first light path;
a hybrid reflective intermediate image screen characterized by at least i) a field correction term that defines a carrier shape of the hybrid reflective intermediate image screen and ii) a diffuser term that defines a surface structure on the hybrid reflective intermediate image screen, wherein the hybrid reflective intermediate image screen receives the light from the picture generating unit; and
at least one mirror that receives the light, after reflection and diffusion at the hybrid reflective intermediate image screen, in a second light path;
wherein the head up display system is configured so that a windshield of the vehicle receives the light after reflection at the mirror, and reflects the light toward the occupant.

2. The windshield head up display system of claim 1, wherein the carrier shape of the hybrid reflective intermediate image screen is curved.

3. The windshield head up display system of claim 1, wherein the field correction term is described as an optical freeform.

4. The windshield head up display system of claim 3, wherein the optical freeform is a two-dimensional polynomial function.

5. The windshield head up display system of claim 1, wherein the field correction term is described as a biconic surface function.

6. The windshield head up display system of claim 1, wherein the field correction term is described as a cylindrical surface function.

7. The windshield head up display system of claim 6, wherein the hybrid reflective intermediate image screen has a radius of curvature of about 1000-300 millimeters and is convex.

8. The windshield head up display system of claim 1, wherein the field correction term is described by an anamorphic lens function.

9. The windshield head up display system of claim 1, wherein the hybrid reflective intermediate image screen has a convex shape facing an origin of the first light path.

10. The windshield head up display system of claim 1, wherein the surface structure has a total height of at least two and a half times a longest illumination wavelength used, and wherein lateral structure sizes are greater than five times the longest illumination wavelength.

11. The windshield head up display system of claim 1, wherein the diffuser term is realized by a deterministic non-stochastical computed surface according to a specified height profile.

12. The windshield head up display system of claim 11, wherein the surface structure has no steps, jumps or edges in both lateral directions, and wherein a first derivative of a surface height function is continuous.

13. The windshield head up display system of claim 11, wherein the surface structure is described by a repetition of one or more unit cells.

14. The windshield head up display system of claim 13, where the unit cell is computed by an Iterative Fourier Transform Algorithm.

15. (canceled)

16. The windshield head up display system of claim 1, further comprising a second mirror that receives the light, after reflection at the first mirror, in a third light path, and wherein at least one of the first or second mirror is curved.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. The windshield head up display system of claim 1, wherein the hybrid reflective intermediate image screen comprises a volume holographic polymer element.

31. (canceled)

32. (canceled)

33. (canceled)

34. (canceled)

35. (canceled)

36. The windshield head up display system of claim 1, wherein the hybrid reflective intermediate image screen is formed by gray scale lithography.

37. The windshield head up display system of claim 1, wherein the surface structure is formed in a material selected from the group consisting of polymer or plastic.

38. The windshield head up display system of claim 37, wherein the material is coated with a reflective layer.

39. (canceled)

40. The windshield head up display system of claim 38, wherein the reflective layer includes a combination of metal and dielectric layers.
